(19) United States
(12) Patent Application Publication
(10) Pub. No.: US 2024/0014469 A1
(43) Pub. Date: Jan. 11, 2024

(54) COMPOSITE FIBER, SOLID ELECTROLYTE INCLUDING SAME, AND PROCESS FOR MASS PRODUCTION THEREOF

(71) Applicant: INDUSTRY-UNIVERSITY COOPERATION FOUNDATION HANYANG UNIVERSITY ERICA CAMPUS, Ansan-si (KR)

(72) Inventors: Jung Ho Lee, Ansan-si (KR); Sambhaji Shivaji Shinde, Ansan-si (KR); Dong Hyung Kim, Ansan-si (KR); Sung Hae Kim, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/472,589

(22) Filed: Sep. 22, 2023

Related U.S. Application Data
(63) Continuation of application No. PCT/KR2022/004098, filed on Mar. 23, 2022.

(30) Foreign Application Priority Data
Mar. 23, 2021 (KR) 10-2021-0037491
Mar. 23, 2022 (KR) 10-2022-0036285

(51) Int. Cl. H01M 12/02

(52) U.S. Cl. CPC H01M 12/02; H01M 2300/0082; H01M 2300/0091

(57) ABSTRACT

A solid electrolyte is provided. The solid electrolyte may comprise a base composite fiber including bacterial cellulose and chitosan, and DNA bound to the surface of the base composite fiber. Alternatively, a solid electrolyte comprises (a) a base composite fiber including bacterial cellulose and chitosan, and (b) a functional fiber having piperidone as a backbone.

### CROSS REFERENCE TO RELATED APPLICATIONS

This is a continuation of PCT/KR2022/004098 (filed 23 Mar. 2022), which claims the benefit of Republic of Korea Patent Application KR 10-2022-0036285 (filed 23 Mar. 2022) and Republic of Korea Patent Application KR 10-2021-0037491 (filed 23 Mar. 2021). The entire disclosure of each of these priority applications is hereby incorporated by reference herein.

### BACKGROUND OF THE INVENTION

### 1. Field of the Invention

The present application relates to a composite fiber, a solid electrolyte including the same, and a process for mass production thereof.

### 2. Description of the Prior Art

As mid-to-large high-energy applications such as electric vehicles, energy storage systems (ESS) and the like are rapidly growing beyond the existing secondary batteries for small devices and home appliances, the market value of the secondary battery industry was only about 22 billion dollars in 2018, but is expected to grow to about 118 billion dollars by 2025. As such, in order for secondary batteries to be used as medium and large-sized energy storage media, there is a demand for price competitiveness, energy density and stability which are significantly improved more than a current level.

According to these technical needs, research on a secondary battery using a solid electrolyte is being actively conducted.

For example, International Unexamined Patent Publication No. WO2014200198A1 discloses a composite electrode-composite electrolyte assembly in which a composite electrode layer and a composite electrolyte layer are integrated, in which the composite electrode layer includes a current collector and an electrode mixture layer formed on the current collector, in which the electrode mixture layer includes an electrode active material, a conductive material, a cross-linked polymer matrix, a dissociable salt, and an organic solvent, and the composite electrolyte layer includes a cross-linked polymer matrix, inorganic particles, a dissociable salt, and an organic solvent, in which the electrode mixture layer and the composite electrolyte layer are overlapped with each other and physically coupled to each other.

As another example, Korean Registered Patent Publication No. 10-1734301 discloses a method for preparing a solid electrolyte for a lithium battery, which includes a first step of preparing a sol by reacting a first metal precursor composed of a Li precursor, a second metal precursor composed of an Al precursor, a third metal precursor composed of a Ti precursor, and a P precursor with a chelating agent; a second step of heating the sol to prepare a gel; a third step of heating and pyrolyzing the gel; a fourth step of heat-treating the pyrolyzed gel while contacting the same with air; a fifth step of cooling the powder obtained through the fourth step; a sixth step of mixing 0.2 to 1 wt % of sintering aid Bi₂O₃ with the powder cooled in the fifth step; and a seventh step of press-molding the mixed powder obtained in the sixth step and sintering the same at 850° C. while contacting the same with air, in which a sintered body has relative density (%) of 90.0 to 99.7 and an ionic conductivity (S cm⁻¹) of 7.9×10⁻⁴ to 9.9×10⁻⁴.

### SUMMARY OF THE INVENTION

One technical object of the present application is to provide a solid electrolyte having high reliability and high ionic conductivity, and a method for preparing the same.

Another technical object of the present application is to provide a solid electrolyte having a long life and a method for preparing the same.

Still another technical object of the present invention is to provide a solid electrolyte having flexibility and high mechanical stability and a method for preparing the same.

Still another technical object of the present application is to provide a secondary battery including a solid electrolyte with an improved charge/discharge capacity and an improved life.

Still another technical object of the present invention is to provide a composite fiber and a membrane for a solid electrolyte and a method for preparing the same.

Still another technical object of the present application is to provide a solid electrolyte, which is operable in high and low temperature environments, and a method for preparing the same.

Still another technical object of the present application is to provide a solid electrolyte, which maintains a high ionic conductivity in high and low temperature environments, and a method for preparing the same.

Still another technical object of the present invention is to provide a solid electrolyte having flexibility and high mechanical stability in high and low temperature environments, and a method for preparing the same.

Still another technical object of the present application is to provide a secondary battery including a solid electrolyte, which is operable in high and low temperature environments.

Still another technical object of the present application is to provide a secondary battery having a high charge/discharge capacity in high and low temperature environments, as well as a long life.

The technical objects of the present application are not limited to the above.

To solve the above technical objects, the present application may provide a solid electrolyte.

According to one embodiment, the solid electrolyte may include a base composite fiber including bacterial cellulose and chitosan, and DNA bound to a surface of the base composite fiber.

According to one embodiment, the solid electrolyte may include a carboxyl group or a DABCO group, which is bound to a surface of the base composite fiber.

According to one embodiment, a low-temperature operation property of the solid electrolyte may be improved by the DNA.

According to one embodiment, the solid electrolyte may comprise a base composite fiber including bacterial cellulose and chitosan, and a functional fiber having piperidone as backbone.

According to one embodiment, the solid electrolyte may further include a terphenyl group bound to a surface of the functional fiber.

According to one embodiment, a high-temperature operation property of the solid electrolyte may be improved by the functional fiber.

According to one embodiment, the solid electrolyte may include a first composite fiber that is formed as a surface of the base composite fiber is oxidized; and a second composite fiber that is formed as a first functional group having nitrogen is bound to a surface of the base composite fiber.

To solve the above technical objects, the present application may provide a method for preparing a solid electrolyte.

According to one embodiment, the method for preparing a solid electrolyte may include: providing a base composite fiber including bacterial cellulose and chitosan; adding oxidized chitosan to a solvent and mixing with the base composite fiber to prepare a mixture; and adding DNA to the mixture and causing a reaction therebetween to bind the DNA to a surface of the base composite fiber.

According to one embodiment, the oxidized chitosan may be prepared by treating the chitosan with sodium hydroxide.

According to one embodiment, the method for preparing a solid electrolyte may include: providing a base composite fiber including bacterial cellulose and chitosan; providing a functional fiber having piperidone as backbone; and mixing the base composite fiber and the functional fiber to prepare solid electrolyte.

According to one embodiment, the solid electrolyte may further include a terphenyl group bound to a surface of the functional fiber.

According to an embodiment of the present application, a solid electrolyte may include a membrane including cellulose, and chitosan bound to the cellulose of the membrane. The solid electrolyte may be provided in the form of a membrane in which the base composite fiber forms a network. The solid electrolyte may contain a large amount of OH ions and moisture by the chitosan, and may have a high ionic conductivity.

In addition, the solid electrolyte may include DNA bound to a surface of the base composite fiber, and thus a low-temperature property may be improved.

Furthermore, the solid electrolyte may further include piperidone, and thus a high-temperature property may be improved.

### BRIEF DESCRIPTION OF THE DRAWINGS

FIG. 1 is a flowchart for explaining a method for preparing a solid electrolyte according to an embodiment of the present application.

FIG. 2 is a view showing a base composite fiber according to an embodiment of the present application.

FIG. 3 is a view showing a first composite fiber according to an embodiment of the present application.

FIG. 4 is a view showing a second composite fiber according to an embodiment of the present application.

FIGS. 5 and 6 are views showing a third composite fiber according to an embodiment of the present application.

FIG. 7 is a view showing a functional fiber according to an embodiment of the present application.

FIG. 8 is a view showing a solid electrolyte including a base composite fiber according to an embodiment of the present application.

FIG. 9 is a view showing a metal-air battery including a solid electrolyte according to an embodiment of the present application.

FIG. 10 is a view for explaining a first composite fiber according to Experimental Example 1-2 of the present application, and a method for preparing the same.

FIG. 11 is a view for explaining a second composite fiber according to Experimental Example 1-3 of the present application, and a method for preparing the same.

FIG. 12 is a view for explaining a method for preparing a solid electrolyte according to Experimental Example 1-4 of the present application.

FIG. 13 is a view for explaining a principle of ion transport in a solid electrolyte according to Experimental Example 1-4 of the present application.

FIG. 14 is a view showing results of a hydrogen NMR analysis on a first composite fiber, a second composite fiber, and a solid electrolyte prepared according to Experimental Examples 1-2 to 1-4 of the present application.

FIG. 15 is a view showing results of an XRD analysis on a solid electrolyte, bacterial cellulose, general bacterial cellulose, and cellulose prepared according to Experimental Examples 1-4 to 1-7 of the present application.

FIG. 16 is a view showing results of an FT-IR analysis on a solid electrolyte, bacterial cellulose, and general bacterial cellulose prepared according to Experimental Examples 1-4 to 1-6 of the present application.

FIG. 17 is an SEM picture of a solid electrolyte prepared according to Experimental Example 1-4 of the present application.

FIG. 18 is a graph for explaining results of measuring a voltage of a solid electrolyte according to Experimental Example 1-4 of the present application.

FIG. 19 is a graph for explaining a charge/discharge capacity of a metal-air battery including a solid electrolyte according to Experimental Example 1-4 of the present application.

FIG. 20 is a graph showing results of measuring a voltage value of a metal-air battery including a solid electrolyte according to Experimental Example 1-4 of the present application depending on the number of charges/discharges.

FIG. 21 is a graph for explaining a change in charge/discharge properties of a metal-air battery including a solid electrolyte according to Experimental Example 1-4 of the present application depending on an external temperature condition.

FIG. 22 is a view for explaining retention properties of a metal-air battery including a solid electrolyte according to Experimental Example 1-4 of the present application depending on the number of charges/discharges in low and high environments.

FIG. 23 provides graphs for explaining charge/discharge properties of a metal-air battery including a solid electrolyte according to Experimental Example 1-4 of the present application depending on an external temperature.

FIG. 24 provides graphs for explaining a capacity property of a metal-air battery including a solid electrolyte according to Experimental Example 1-4 of the present application depending on an external temperature.

FIG. 25 provides graphs for explaining a change in charge/discharge properties of a metal-air battery including a solid electrolyte according to Experimental Example 1-4 of the present application depending on a charge/discharge cycle caused by an external temperature.

FIG. 26 is a view showing pictures of an SEM image of a solid electrolyte including a third composite fiber according to Experimental Example 2-4 of the present application.

FIG. 27 is a view showing SEM pictures of and results of an EDS analysis on a solid electrolyte including a third composite fiber according to Experimental Example 2-4 of the present application.

FIG. 28 is a view showing results of measuring an ionic conductivity of a solid electrolyte including a third composite fiber according to Experimental Example 2-4 of the present application depending on a temperature.

FIG. 29 is a view showing SEM pictures of a solid electrolyte including a third composite fiber according to Experimental Example 2-4 and a functional fiber according to Experimental Example 2-5 of the present application.

FIG. 30 is a view showing results of an EDS analysis on a solid electrolyte including a functional fiber according to Experimental Example 2-5 of the present application.

FIG. 31 is a view showing results of measuring an ionic conductivity of a solid electrolyte including a functional fiber according to Experimental Example 2-5 of the present application depending on a temperature.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. The embodiments introduced herein are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of membranes and areas are exaggerated for efficient description of the technical contents.

In addition, in the various embodiments of the present specification, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. Further, in the following description of the present invention, a detailed description of known functions and configurations incorporated herein will be omitted when it may make the subject matter of the present invention unnecessarily unclear.

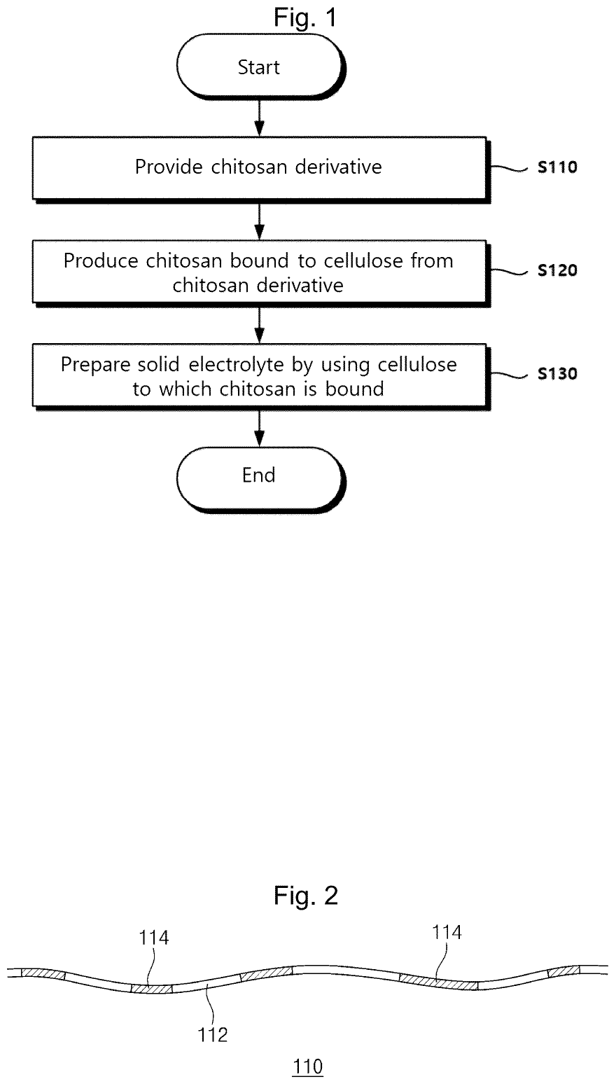

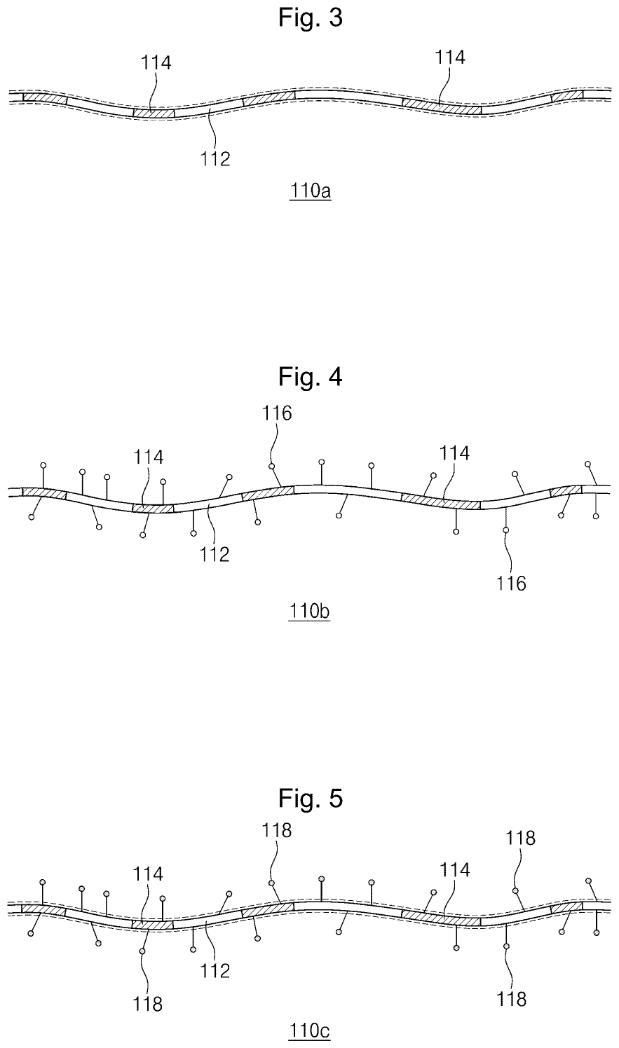

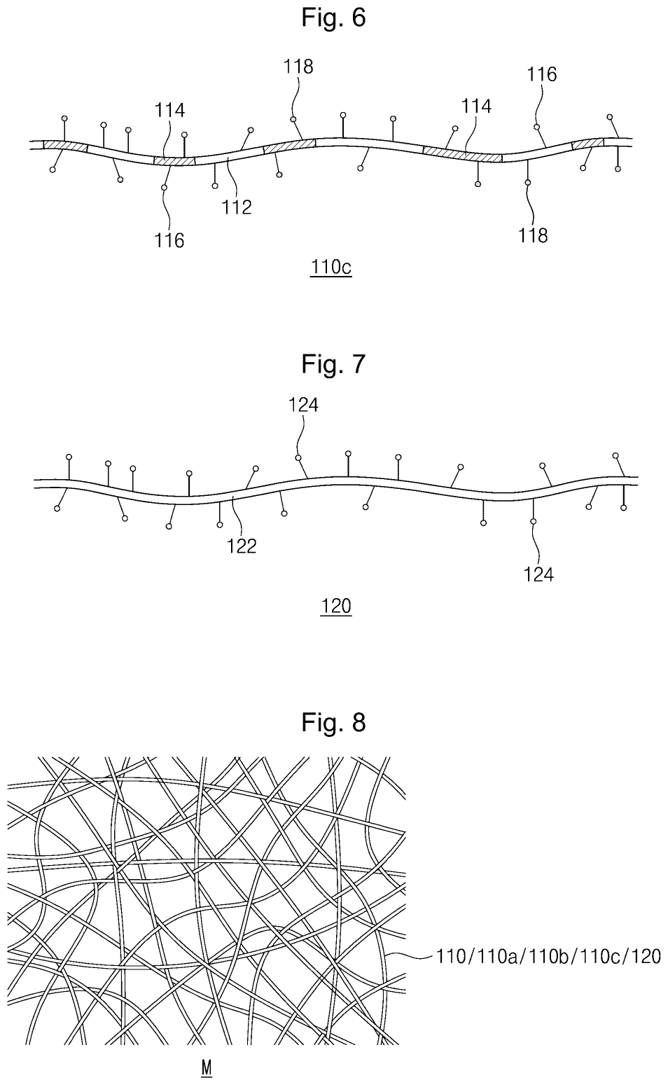

FIG. 1 is a flowchart for explaining a method for preparing a solid electrolyte according to an embodiment of the present application, FIG. 2 is a view showing a base composite fiber according to an embodiment of the present application, FIG. 3 is a view showing a first composite fiber according to an embodiment of the present application, FIG. 4 is a view showing a second composite fiber according to an embodiment of the present application, FIGS. 5 and 6 are views showing a third composite fiber according to an embodiment of the present application, FIG. 7 is a view showing a functional fiber according to an embodiment of the present application, and FIG. 8 is a view showing a solid electrolyte including a base composite fiber according to an embodiment of the present application.

Referring to FIGS. 1 to 5, a chitosan derivative may be prepared (S110).

The chitosan derivative may be obtained by mixing a chitosan precursor in a solvent. According to one embodiment, the chitosan derivative may be obtained by adding a solubilizer to chitosan chloride and solvent. Accordingly, the chitosan chloride may be easily dissolved in the solvent, and the chitosan derivative may be easily provided to a medium to be described below, thereby easily preparing a cellulose to which chitosan is bound.

For example, the solvent may be aqueous acetic acid, and the solubilizer may include at least one of glycidyltrimethylammonium chloride, (2-aminoethyl)trimethylammonium chloride, (2-chloroethyl)trimethylammonium chloride, (3-carboxypropyl)trimethylammonium chloride, or (formylmethyl)trimethylammonium chloride.

The chitosan may have excellent thermal and chemical stabilities as well as a high ion conductivity, and may contain OH ions without a long-term loss. In addition, as described below, when used in a metal-air battery, it may have high compatibility with a zinc negative electrode and a compound structure of copper, phosphorus and sulfur.

Alternatively, according to another embodiment, the chitosan derivative may be used as a commercial product.

A base composite fiber including chitosan bound to cellulose may be produced from the chitosan derivative (S120). The producing of the cellulose to which the chitosan is bound may include: preparing a culture medium having the chitosan derivative; and injecting and culturing a bacterial strain in the culture medium to produce a base composite fiber 110 including cellulose 112 to which chitosan 114 is bound. In this case, the cellulose 112 may be bacterial cellulose.

According to one embodiment, the cellulose 112 to which the chitosan 114 is bound may be prepared by culturing a bacterial pellicle in the culture medium and then desalinating the bacterial pellicle. The bacterial pellicle may be prepared by preparing a culture medium containing the chitosan derivative together with raw materials (for example, pineapple juice, peptone, disodium phosphate, and citric acid) for culturing yeast and bacteria, injecting a strain, and then culturing the same. For example, the strain may be Acetobacter xylinum.

The cultured bacterial pellicle may be washed, dried, desalted with an acidic solution (for example, HCl) and neutralized, and then the solvent may be removed to prepare the base composite fiber 110 including the cellulose 112 to which the chitosan 114 is bound. In the desalting process, the remaining Na, K, or cell shields and debris may be removed to prepare the cellulose 112 to which the chitosan 114 with high purity is bound.

In addition, the chitosan 114 may be chemically bound to the cellulose 112. Accordingly, in the cellulose 112 to which the chitosan 114 is bound, stretchable vibration corresponding to C—N may be observed during XPS analysis.

Unlike the above, according to another embodiment, the cellulose 112 to which the chitosan 114 is bound may be prepared by culturing a bacterial pellicle in the culture medium, washing with an alkali solution to remove unreacted bacterial cells, performing centrifugation and purification with deionized water, and evaporating the solvent. In other words, the desalting process using the acidic solution described above may be omitted.

According to one embodiment, a first composite fiber 110a may be prepared as a surface of the cellulose 112 to which the chitosan 114 is bound, that is, a surface of the base composite fiber 110 is oxidized by using an oxidizing agent.

Specifically, the preparing of the first composite fiber 110a may include: adding the base composite fiber 110 to an aqueous solution containing an oxidizing agent to prepare a source solution; adjusting the pH of the source solution to be basic; adjusting the pH of the source solution to be neutral; and washing and drying the pulp in the source solution to prepare the first composite fiber 110a.

For example, the aqueous solution containing the oxidizing agent may be an aqueous TEMPO solution. Alternatively, as another example, the aqueous solution containing the oxidizing agent may include at least one of 4-hydroxy-TEMPO, (diacetoxyiodo)benzene, 4-amino-TEMPO, 4-carboxy-TEMPO, 4-methoxy-TEMPO, TEMPO methacrylate, 4-acetamido-TEMPO, 3-carboxy-PROXYL, 4-maleimido-TEMPO, 4-hydroxy-TEMPO benzoate, or 4-phosphonooxy-TEMPO.

The source solution may further include a sacrificial reagent and an additional oxidizing agent for the oxidation reaction of the base composite fiber 110. For example, the sacrificial reagent may include at least one of NaBr, sodium iodide, sodium bromate, sodium bromite, sodium borate, sodium chlorite, or sodium chloride, and the additional oxidizing agent may include at least one of NaClO, potassium hypochlorite, lithium hypochlorite, sodium chlorite, sodium chlorate, perchloric acid, potassium perchlorate, lithium perchlorate, tetrabutylammonium perchlorate, zinc perchlorate, hydrogen peroxide, or sodium peroxide.

According to one embodiment, the adjusting of the pH of the source solution to be basic, the pH of the source solution may be adjusted to 10. Accordingly, the oxidation reaction may be easily induced while a precipitate is minimized, and a degree of oxidation of the first composite fiber 110a may be improved as compared to the reaction condition of pH 8-9.

According to one embodiment, after the base composite fiber 110 and the sacrificial reagent are provided to the aqueous solution containing the oxidizing agent, the additional oxidizing agent may be provided. In addition, the additional oxidizing agent may be provided dropwise. Accordingly, an abrupt oxidation phenomenon of the base composite fiber 110 may be prevented, and as a result, the surface of the base composite fiber 110 may be uniformly and stably oxidized.

In addition, according to one embodiment, a second composite fiber 110b may be prepared by binding bromine to the surface of the cellulose 112 to which the chitosan 114 is bound and substituting a first functional group 116 including nitrogen with bromine.

The first functional group 116 may be represented by <Formula 1> below, and the first functional group 116 may be bound to the chitosan 114 and/or the cellulose 112.

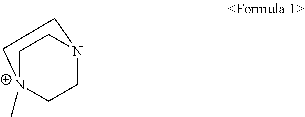

In other words, the second composite fiber 110b may have quaternary N.

Specifically, the preparing of the second composite fiber 110b may include: preparing a first source solution by dispersing the base composite fiber 110 in a first solvent and adding a bromine source; preparing a reaction suspension by adding a coupling agent to the first source solution and causing a reaction therebetween; preparing a brominated base composite fiber by filtering, washing and freeze-drying the reaction suspension; preparing a second source solution by dispersing the brominated base composite fiber in a second solvent; adding a precursor of the first functional group 116 to the second source solution and causing a reaction therebetween; and preparing the second composite fiber 110b by filtering, washing and freeze-drying the reacted solution.

For example, the first solvent and the second solvent may be the same as each other, and may include at least one of N, N-dimethylacetamide, acetamide, acetonitrile, ethanol, ethylenediamine, diethyl ether, or benzaldehyde.

For example, the bromine source may include at least one of LiBr, sodium bromide, or potassium bromide.

For example, the coupling agent may include N-bromosuccinimide and triphenylphosphine. Bromine may be easily bound to a surface of the base composite fiber 110 by the coupling agent. Specifically, bromine in N-bromosuccinimide may be bound to the base composite fiber 110, and triphenylphosphine may reduce a bromine precursor (bromine source or N-bromosuccinimide) to improve a reaction rate.

As described above, after obtaining the base composite fiber brominated in the reaction suspension, the brominated base composite fiber may be freeze-dried. Accordingly, a loss of bromine in the brominated base composite fiber may be minimized, and a secondary reaction of bromine with other elements may be minimized.

For example, a precursor of the first functional group 116 may include 1,4-diazabicyclo[2.2.2]octane.

In addition, according to one embodiment, a third composite fiber 110c in which DNA 118 is bound to a surface of the cellulose 112 to which the chitosan 114 is bound, may be prepared.

The binding of the DNA 118 to the base composite fiber 110 having the cellulose 112 to which the chitosan 114 is bound may include: providing the base composite fiber 110 including the cellulose 112 and the chitosan 114; adding oxidized chitosan to a solvent and mixing with the base composite fiber 110 to prepare a mixture; and adding the DNA 118 to the mixture and causing a reaction therebetween to bind the DNA 118 to a surface of the base composite fiber 110. The DNA 118 may be easily bound to the base composite fiber 110 via the oxidized chitosan. Specifically, the oxidized chitosan and the DNA 118 may be reacted, and then the reactant may be chemically bound to the base composite fiber 110, and the oxidized chitosan may be removed in a washing process.

According to one embodiment, the base composite fiber 110 may include the first composite fiber 110a that is formed as a surface of the base composite fiber 110 is oxidized and/or the second composite fiber 110b that is formed as the first functional group 116 is bound to a surface of the base composite fiber 110. In other words, as shown in FIGS. 5 and 6, the DNA 118 may be bound to the first composite fiber 110a described with reference to FIG. 3 or the surface of the second composite fiber 110b described with reference to FIG. 4. In other words, the third composite fiber 110c to which the DNA 118 is bound may be formed by binding the DNA 118 to at least one of the base composite fiber 110, the first composite fiber 110a, and the second composite fiber 110b. As described later, a low-temperature operation property of a solid electrolyte may be improved by the DNA 118.

In addition to the DNA 118, a carboxyl group or a DABCO group may be further bound to the surface of the third composite fiber 110c.

A solid electrolyte may be prepared using the cellulose 112 to which the chitosan 114 is bound (S130).

As shown in FIG. 8, the solid electrolyte may be prepared in the form of a membrane M in which the base composite fiber 110 including the cellulose 112 to which the chitosan 114 is bound forms a network. Accordingly, the solid electrolyte may have a plurality of pores provided therein, may have a high surface area, and may have excellent flexibility and mechanical property.

The solid electrolyte may be in a state in which a crystalline phase and an amorphous phase are mixed. More specifically, the solid electrolyte may have a ratio of an amorphous phase higher than a ratio of a crystalline phase.

Accordingly, the solid electrolyte may have a high ionic mobility.

In addition, when the solid electrolyte is mounted on a metal-air battery, the metal-air battery may smoothly perform charge/discharge operations at low and high temperatures. In other words, the metal-air battery including the solid electrolyte according to an embodiment of the present application may smoothly operate at low and high temperatures, have a wide range of operating temperatures, and be used in various environments.

According to one embodiment, the solid electrolyte may be prepared by a gelatin process using the first composite fiber 110a and the second composite fiber 110b. In this case, the solid electrolyte may include the first composite fiber 110a and the second composite fiber 110b, in which the first composite fiber 110a and the second composite fiber 110b may be cross-linked to each other. Due to the first composite fiber 110a, the number of OH ions in the solid electrolyte may be increased, ionic conductivity may be improved, a negative charge density may be increased, and swelling resistance may be improved. In addition, due to the second composite fiber 110b, thermal stability may be improved due to an increase in molecular weight, ion exchange capacity may be improved to have a high moisture impregnation rate and a high swelling resistance, cross-linking binding strength with the first composite fiber 110a may be improved, and ion discerning selectivity with a specific solvent may be selectively high. Accordingly, a secondary battery including the solid electrolyte may have improved a charge/discharge property and a life property.

Specifically, the preparing of the solid electrolyte may include: mixing the first composite fiber 110a and the second composite fiber 110b with a solvent to prepare a mixed solution; adding a crosslinking agent and an initiator to the mixed solution and causing a reaction therebetween to prepare a suspension; casting the suspension on a substrate and drying the same to prepare a composite fiber membrane; and performing an ion exchange process on the composite fiber membrane.

For example, the solvent may include a mixed solvent of methylene chloride, 1,2-propanediol, and acetone, the crosslinking agent may include glutaraldehyde, and the initiator may include N,N-diethyl-N-methyl-N-(2-methoxyethyl) ammonium bis(trifluoromethanesulfonyl)imide.

In addition, for example, an ion exchange process for the composite fiber membrane may include providing a KOH aqueous solution and a ZnTFSI aqueous solution to the composite fiber membrane. Accordingly, the content of OH ions in the solid electrolyte may be improved.

As described above, according to an embodiment of the present application, the solid electrolyte may include the membrane M including at least one of the base composite fiber 110, the first composite fiber 110a, or the second composite fiber 110b.

A ratio of the chitosan 114 in the solid electrolyte may be easily controlled according to a content of the chitosan derivative provided in the culture medium. The crystallinity, ionic conductivity, and swelling ratio of the solid electrolyte may be controlled according to a ratio of the chitosan 114. Specifically, as the ratio of the chitosan 114 increases, the crystallinity of the solid electrolyte may gradually decrease.

According to one embodiment, the content of the chitosan 114 may be greater than 30 wt % and less than 70 wt %. If the content of the chitosan 114 is equal to or less than 30 wt % or equal to or greater than 70 wt %, the ionic conductivity of the solid electrolyte may be remarkably reduced, and the swelling ratio may be remarkably increased.

However, according to an embodiment of the present application, the ratio of the chitosan 114 in the solid electrolyte may be greater than 30 wt % and less than 70 wt %, and thus the solid electrolyte may have a low swelling ratio value while a high ionic conductivity property is maintained.

Alternatively, according to another embodiment, the solid electrolyte may be prepared using the third composite fiber 110c. Specifically, the solid electrolyte may be prepared by a method of mixing the third composite fiber 110c (for example, the first composite fiber 110a to which the DNA 118 is bound and/or the second composite fiber 110b to which the DNA 118 is bound) with a solvent, casting the solvent mixed with the third composite fiber 110c onto a substrate, drying the same to prepare a composite fiber membrane, and performing an ion exchange process (for example, ion exchange at normal temperature at 1 M KOH aqueous solution and 0.1 M ZnTFSI for six hours, respectively) on the composite fiber membrane.

Alternatively, according to another embodiment, the functional fiber 120 shown in FIG. 7 may be added to the solid electrolyte including at least one of the base composite fiber 110, the first composite fiber 110a, the second composite fiber 110b, or the third composite fiber 110c.

The functional fiber 120 may have piperidone 122 as a backbone, and a terphenyl group 124 may be bound to a surface of the functional fiber 120.

The preparing of the solid electrolyte to which the functional fiber 120 is further added may include a method of mixing at least one of the base composite fiber 110, the first composite fiber 110a, the second composite fiber 110b, and the third composite fiber 110c with the functional fiber 120 in a solvent, casting the mixed solvent on a substrate, drying the same to prepare a composite fiber membrane, and performing an ion exchange process on the composite fiber membrane.

The functional fiber 120 may be further added to the solid electrolyte, thereby improving a high temperature operation property of the solid electrolyte as described below.

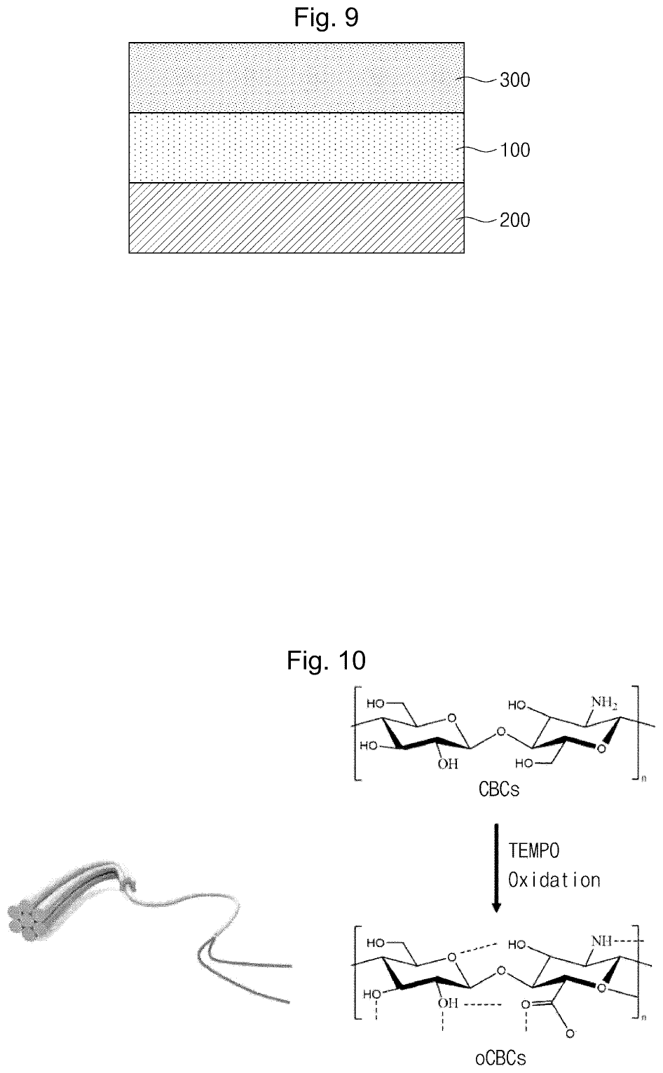

FIG. 9 is a view showing a metal-air battery including a solid electrolyte according to an embodiment of the present application.

Referring to FIG. 9, a metal-air battery according to an embodiment of the present application may be provided. The metal-air battery may include a negative electrode 200, a positive electrode 300, and a solid electrolyte 100 between the negative electrode 200 and the positive electrode 300.

The solid electrolyte 100 may be provided in the form of a membrane including at least one of the base composite fiber 110, the first composite fiber 110a, the second composite fiber 110b, and the third composite fiber 110c described with reference to FIGS. 1 to 7. Alternatively, the functional fiber 120 described with reference to FIG. 8 may be further included.

The negative electrode 200 may include zinc. Alternatively, in contrast, the negative electrode 200 may include lithium.

According to one embodiment, the positive electrode 300 may include Pt/C and RuO₂. Alternatively, according to another embodiment, the positive electrode 300 may include a compound structure of copper, phosphorus, and sulfur. In this case, a compound structure of copper, phosphorus, and sulfur may be provided in a form in which a plurality of fibrillated fibers form a membrane, and may have a crystal plane 101. A detailed process of preparing the compound structure of copper, phosphorus, and sulfur will be described later with reference to FIG. 19.

The solid electrolyte 100 included in the metal-air battery according to an embodiment of the present application may contain a large amount of OH ions and moisture and may have a high OH ionic conductivity. Accordingly, the charge/discharge capacity and life property of the metal-air battery may be improved, and the growth of the dendrites on a surface of the negative electrode 200 may be minimized in a process of charging and discharging the metal-air battery.

Hereinafter, a method for preparing a base composite fiber, a first composite fiber, a second composite fiber, and a solid electrolyte will be described according to specific experimental examples of the present application.

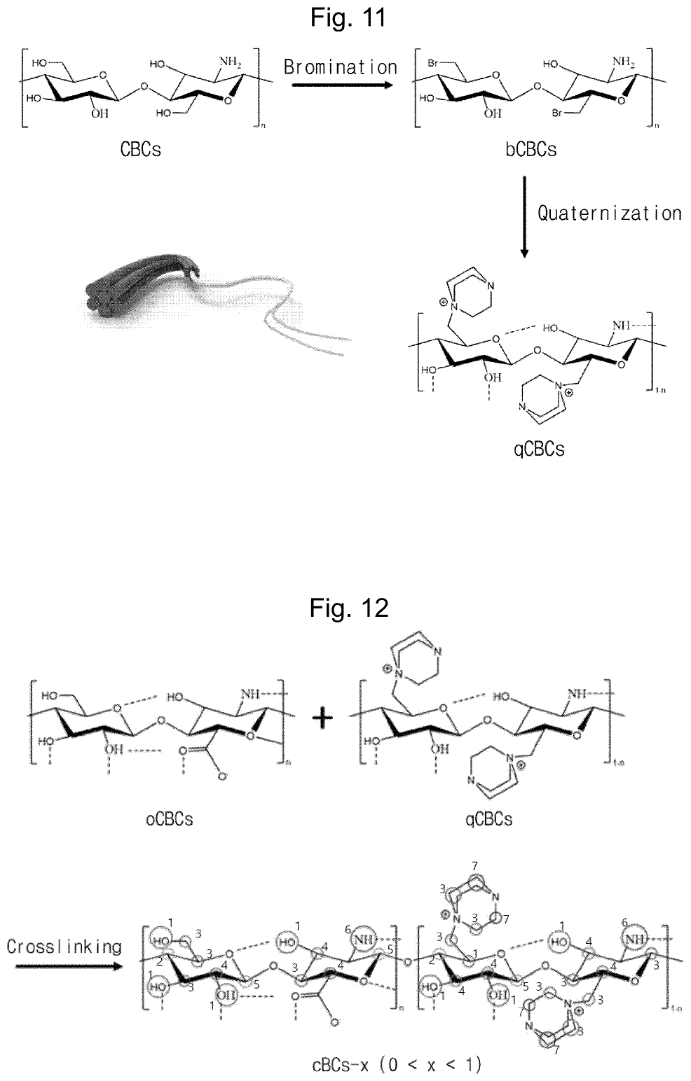

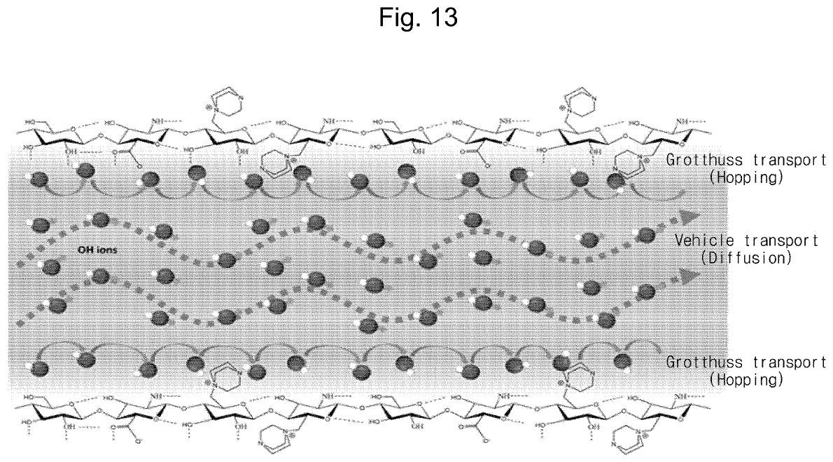

FIG. 10 is a view for explaining a first composite fiber according to Experimental Example 1-2 of the present application, and a method for preparing the same, FIG. 11 is a view for explaining a second composite fiber according to Experimental Example 1-3 of the present application, and a method for preparing the same, FIG. 12 is a view for explaining a method for preparing a solid electrolyte according to Experimental Example 1-4 of the present application, and FIG. 13 is a view for explaining a principle of ion transport in a solid electrolyte according to Experimental Example 1-4 of the present application.

### Preparing of Base Composite Fiber (CBC) According to Experimental Example 1-1

Acetobacter xylinum was provided as a bacterial strain, and a chitosan derivative was provided. The chitosan derivative was prepared by dissolving 1 g of chitosan chloride in 1% (v/v) aqueous acetic acid, treating the resulting suspension with 1 M glycidyltrimethylammonium chloride at 65° C. for 24 hours in an N₂ atmosphere, precipitating, and filtering multiple times with ethanol.

A Hestrin-Schramm (HS) culture medium containing pineapple juice (2% w/v), yeast (0.5% w/v), peptone (0.5% w/v), disodium phosphate (0.27% w/v), citric acid (0.015% w/v), and the chitosan derivative (2% w/v) was prepared and steam-sterilized at 121° C. for 20 minutes. In addition, Acetobacter xylinum was activated in a pre-cultivation Hestrin-Schramm (HS) culture medium at 30° C. for 24 hours, and then acetic acid was added to maintain pH 6.

After that, Acetobacter xylinum was cultured in the Hestrin-Schramm (HS) culture medium at 30° C. for seven days.

The harvested bacterial pellicle was washed with deionized water to neutralize the pH of the supernatant and dehydrated in vacuum at 105° C. The resulting cellulose was demineralized by using 1 N HCl for 30 minutes (a mass ratio of 1:15, w/v) to remove an excessive amount of reagent, and then was purified a plurality of times by centrifugation with deionized water until the supernatant reached a neutral pH. Finally, all solvents were evaporated at 100° C. to prepare a base composite fiber (chitosan-bacterial cellulose (CBC)).

### Preparing of First Composite Fiber (oCBC) According to Experimental Example 1-2

A first composite fiber (TEMPO-oxidized CBC (oCBCs)) that is formed as a surface of the base composite fiber is oxidized according to Experimental Example 1-1 was designed according to a method for conjugating a base composite fiber (CBC) of hydroxymethyl and ortho-para directing acetamido to an oxide of TEMPO by an oxidation reaction using 2,2,6,6-tetramethylpiperidin-1-oxyl (TEMPO), sodium bromide (NaBr) and sodium hypochlorite (NaClO) as shown in FIG. 7.

Specifically, 2 g of the base composite fiber dispersed in a 2 mM TEMPO aqueous solution was reacted with NaBr (1.9 mM). 5 mM NaClO was used as an additional oxidizing agent.

The reaction suspension was stirred with ultrasonic waves and subjected to a reaction at room temperature for three hours. The pH of the suspension was maintained at 10 by successive addition of 0.5 M NaOH solution. Then, 1 N HCl was added to the suspension to keep the pH neutral for three hours. The oxidized pulp produced in the suspension was washed three times with 0.5 N HCl, and the supernatant was brought to a neutral pH with deionized water.

The washed pulp was exchanged with acetone and toluene for 30 minutes and dried to evaporate the solvent, and finally a first composite fiber (oCBC) was obtained.

As can be understood from FIG. 10, the surface of the base composite fiber may be oxidized.

### Preparing of Second Composite Fiber (qCBC) According to Experimental Example 2-3

A second composite fiber (covalently quaternized CBC (qCBC)) that is formed as a first functional group having nitrogen is bound to the base composite fiber according to Experimental Example 1-1, was prepared according to a method for conjugating a brominated base composite fiber (CBC) and a quaternary amine group by a coupling agent using 1,4-diazabicyclo[2.2.2]octane, as shown in FIG. 8.

Specifically, 1 g of the base composite fiber dispersed in N,N-dimethylacetamide (35 ml) solution was reacted with LiBr (1.25 g) suspension while being stirred for 30 minutes. N-bromosuccinimide (2.1 g) and triphenylphosphine (3.2 g) were used as a coupling agent. The two reaction mixtures were stirred for 10 minutes and reacted at 80° C. for 60 minutes.

Then, the reaction suspension was cooled to room temperature, added to deionized water, filtered, rinsed with deionized water and ethanol, and freeze-dried to obtain a brominated base composite (bCBC) fiber.

The brominated base composite fiber was dissolved in 100 ml of N,N-dimethylformamide, and reacted with 1.2 g of 1,4-diazabicyclo[2.2.2]octane.

After that, the mixture was subjected to ultrasonic treatment for 30 minutes, and then reacted at room temperature for 24 hours. The resulting solution was mixed with diethyl ether, washed five times with diethyl ether/ethyl acetate, and freeze-dried to obtain a second composite fiber (covalently quaternized CBC (qCBC)).

As can be understood from FIG. 11, it can be confirmed that the first functional group having nitrogen is bound to the surface of the base composite fiber.

### Preparing of Solid Electrolyte (CBCs) According to Experimental Example 1-4

A solid electrolyte was prepared by a gelatin process using the first composite fiber (oCBC) according to Experimental Example 1-2 and the second composite fiber (qCBC) according to Experimental Example 1-3, as shown in FIG. 12. Specifically, the first composite fiber (oCBC) and the second composite fiber (qCBC) were dissolved in a mixture of methylene chloride, 1,2-propanediol and acetone (8:1:1 v/v/v %) at the same weight ratio by using ultrasonic waves, and then 1 wt % of glutaraldehyde as a crosslinking agent and 0.3 wt % of N,N-diethyl-N-methyl-N-(2-methoxyethyl) ammonium bis(trifluoromethanesulfonyl)imide as an initiator were added.

A vacuum chamber (200 Pa) was used to remove air bubbles from the gel suspension and cast on glass at 60° C. for six hours. A composite fiber membrane was peeled off while being coagulated with deionized water, rinsed with deionized water, and vacuum dried.

Solid electrolyte (CBCs) were prepared through ion exchange with 1 M KOH aqueous solution and 0.1 M ZnTFSI at normal temperature for six hours, respectively. After that, washing and immersion processes were performed with deionized water in an N₂ atmosphere in order to avoid a reaction with CO₂ and a carbonate formation.

As can be understood from FIG. 12, it can be confirmed that the first composite fiber (oCBC) and the second composite fiber (qCBC) are cross-linked to each other to form the solid electrolyte (CBCs).

In addition, referring to FIG. 113, OH ions may be hopped (grotthuss transport) on the surfaces of the first composite fiber (oCBC) and the second composite fiber (qCBC), which are cross-linked, of the solid electrolyte (CBCs), and may be moved through diffusion inside spaced apart from the surfaces of the first composite fiber and the second composite fiber. Furthermore, the solid electrolyte (CBCs) may have an amorphous phase as described below with reference to FIG. 15, and thus may have a higher ionic conductivity compared to a crystalline structure.

### Preparing of Bacterial Cellulose According to Experimental Example 1-5

In the method for preparing the base composite fiber of Experimental Example 1-1 as described above, bacterial cellulose without chitosan was prepared by omitting the chitosan derivative and omitting the desalting process.

### Preparing of General Bacterial Cellulose According to Experimental Example 1-6

Bacterial cellulose was prepared by the same method as shown in Experimental Example 1-1 with a culture medium containing glucose (2 wt %), peptone (0.5 wt %), yeast (0.5 wt %), disodium phosphate (0.2 wt %), and citric acid (0.1 wt %), but by omitting the chitosan derivative and omitting the desalting process.

### Preparing of Cellulose According to Experimental Example 1-7

Sugarcane bagasse was prepared, and a solvent was prepared by mixing deionized water, NaOH, and nitric acid in ethanol. Sugarcane bagasse was dispersed in a solvent, washed, filtered, and washed multiple times with deionized water until a neutral pH was reached.

The washed sugarcane bagasse was dried at 100° C. for three hours and polished with a stainless steel sieve of 16 mesh IKA MF-10 mill so as to prepare fiber pulp.

A unit process of bleaching the fiber pulp with hydrogen peroxide (1%, pH 13.5) for one hour at 55° C. was repeated three times in total, and the residue was removed with a NaOH solution for three hours in an atmospheric atmosphere, washed with ethanol and acetone, and dried at 50+C for six hours to prepare cellulose.

Experimental Examples 1-1 to 1-7 may be summarized as shown in [Table 1] below.

TABLE 1

| Classification | Structure |
|---|---|
| Experimental Example 1-1 | Base composite fiber (CBC): |
| | Chitosan + Bacterial |
| | cellulose |
| Experimental Example 1-2 | First composite fiber (oCBC): |
| | Surface oxidized chitosan + |
| | Surface oxidized bacterial cellulose |
| Experimental Example 1-3 | Second composite fiber |
| | (qCBC): Chitosan having a |
| | first functional group + |
| | Bacterial cellulose having a |
| | first functional group |
| Experimental Example 1-4 | Crosslinking of first |
| | composite fiber (oCBC) and |
| | second composite fiber (qCBC) |
| Experimental Example 1-5 | Bacterial cellulose without |
| | chitosan |
| Experimental Example 1-6 | Common bacteria cellulose |
| Experimental Example 1-7 | Cellulose |

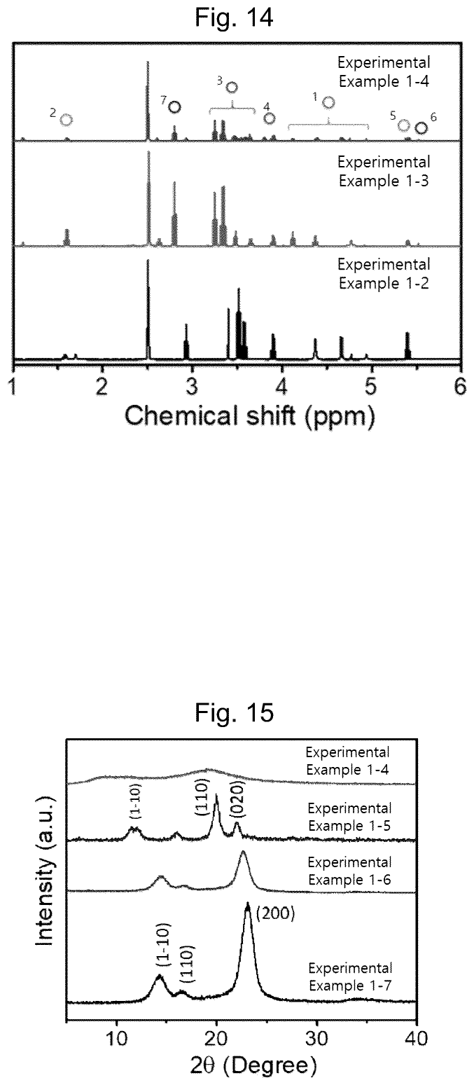

FIG. 14 is a view showing results of a hydrogen NMR analysis on a first composite fiber, a second composite fiber, and a solid electrolyte prepared according to Experimental Examples 1-2 to 1-4 of the present application.

Referring to FIG. 14, a hydrogen NMR analysis was performed on a first composite fiber, a second composite fiber, and a solid electrolyte prepared according to Experimental Examples 1-2 to 1-4 as described above.

As a result of analysis in FIG. 14, circles with numbers indicated correspond to hydrogen atoms corresponding to circles with the same numbers indicated in FIG. 12. In other words, the result of NMR analysis on circles with numbers indicated in FIG. 12 can be confirmed from FIG. 14. As can be understood from FIG. 13, it can be confirmed that the first composite fibers and the second composite fibers are alternately and repeatedly crosslinked at the same ratio.

FIG. 15 is a view showing results of an XRD analysis on a solid electrolyte, bacterial cellulose, general bacterial cellulose, and cellulose prepared according to Experimental Examples 1-4 to 1-7 of the present application.

Referring to FIG. 15, an XRD analysis was performed on a solid electrolyte, bacterial cellulose, general bacterial cellulose, and cellulose prepared according to Experimental Examples 1-4 to 1-7 as described above.

As can be understood from FIG. 15, it can be confirmed that the cellulose fiber of Experimental Example 1-7 has high crystallinity and has peak values corresponding to crystal planes 200, 110 and 1-10, and thus has a hexagonal crystal structure. In contrast, it can be confirmed for the bacterial cellulose C(I) of Experimental Example 1-6 that crystallinity is relatively decreased, and the 20 value of the peak corresponding to the crystal plane 200 is decreased.

For the bacterial cellulose of Experimental Example 1-5 prepared according to an embodiment of the present application, it can be confirmed that crystallinity is remarkably compared to the general cellulose fiber of Experimental Example 1-7, and the bacterial cellulose has a peak value corresponding to the crystal planes 020 and 110 unlike the general cellulose fiber of Experimental Example 1-7 and the general bacterial cellulose of Example 1-6, and has two peak values corresponding to the crystal plane 1-10. In addition, it can be confirmed that the peak value corresponding to the crystal plane 110 is higher than the peak value corresponding to the other crystal planes (e.g., 101 and 1-10).

Furthermore, it can be confirmed that the solid electrolyte of Experimental Example 1-4 prepared according to an embodiment of the present application has a crystalline phase and an amorphous phase at the same time, but the ratio of the amorphous phase is remarkably high.

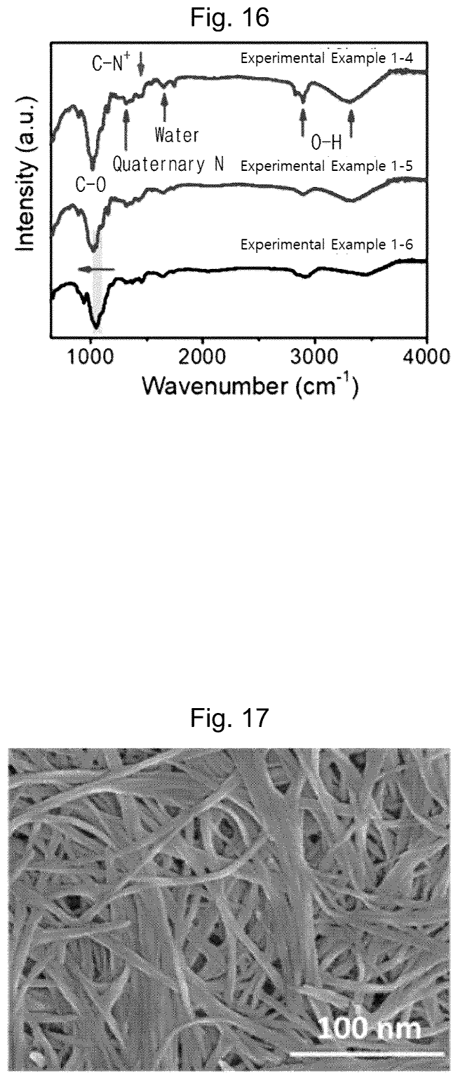

FIG. 16 is a view showing results of an FT-IR analysis on a solid electrolyte, bacterial cellulose, and general bacterial cellulose prepared according to Experimental Examples 1-4 to 1-6 of the present application.

Referring to FIG. 16, an FT-IR analysis was performed on a solid electrolyte, bacterial cellulose, and general bacterial cellulose according to Experimental Examples 1-4 to 1-6 as described above.

As can be understood from FIG. 16, it can be confirmed for the bacterial cellulose of Experimental Example 1-5 that a stretching vibration of C—O and O—H moves from 1056 cm⁻¹ and 2932 cm⁻¹ to 1022 cm⁻¹ and 2895 cm⁻¹ compared to the general bacterial cellulose of Experimental Example 1-6. In addition, it can be confirmed for the solid electrolyte of Experimental Example 1-4 according to an embodiment of the present application that a stretching vibration of C—N⁺ is observed at 1458 cm⁻¹ and thus a quaternization reaction occurs. Vibrations at 2916 cm⁻¹ and 3320 cm⁻¹ correspond to a stretching vibration of O—H, and 1652 cm⁻¹ and 1750 cm⁻¹ correspond to water, and it can be confirmed that sufficient water molecules exist in the amorphous solid electrolyte, and an increase in the intensity of the stretching vibration of C—O in the solid electrolyte of Experimental Example 1-4 is caused by a reaction of chitosan and bacterial cellulose. In addition, it can be confirmed that carbonate is not substantially present in the solid electrolyte of Experimental Example 1-4, and accordingly it can be seen that there is an advantage compared to the commercially available PVA electrolyte.

FIG. 17 is an SEM picture of a solid electrolyte prepared according to Experimental Example 1-4 of the present application.

Referring to FIG. 17, an SEM picture was taken of the solid electrolyte prepared according to Experimental Example 1-4 as described above.

As can be understood from FIG. 17, it can be confirmed that a plurality of pores exist inside, and it can be confirmed that the bacterial cellulose fiber to which chitosan is bound is provided in a fibrillated form and a diameter is 5-10 nm.

It can be seen that a measured pore size is about 20-200 nm and the bacterial cellulose fiber to which chitosan is bound in the solid electrolyte forms a network with a high pore and a high surface area, thereby having a high strength against swelling.

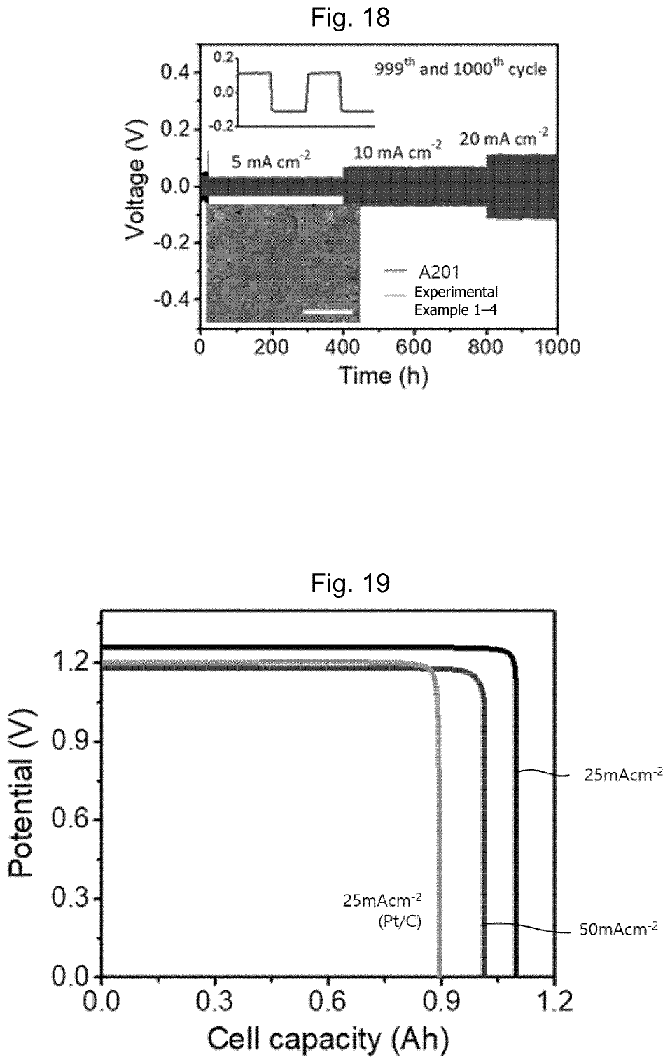

FIG. 18 is a graph for explaining results of measuring a voltage of a solid electrolyte according to Experimental Example 1-4 of the present application.

Referring to FIG. 18, the solid electrolyte according to Experimental Example 1-4 as described above was inserted between zinc electrodes, and voltage was measured under current density conditions of 5 mAcm⁻², 10 mAcm⁻², and 20 mAcm⁻², while A201 membrane was inserted between the zinc electrodes to measure the voltage under the same conditions instead of the solid electrolyte according to Experimental Example 1-4. The graph at the top of FIG. 18 indicates a voltage value in 999 and 1000 consecutive cycles, and the picture at the bottom of FIG. 18 is a SEM picture of the zinc electrode after 1000 times.

As can be understood from FIG. 18, it can be confirmed that when the A201 membrane is used, an operation is not performed after about 23 hours, but when the solid electrolyte according to Experimental Example 1-4 of the present application is used, stable driving is performed up to 1000 times at a high current density.

In addition, as can be understood from an SEM image in a lower part of FIG. 18, it can be confirmed that even if a high density current is applied for a long time, stable driving is performed without generation of dendrites.

FIG. 19 is a graph for explaining a charge/discharge capacity of a metal-air battery including a solid electrolyte according to Experimental Example 1-4 of the present application.

Referring to FIG. 19, a metal-air battery was manufactured using a solid electrolyte according to Experimental Example 1-4 as described above, a positive electrode of a compound structure of copper, phosphorus and sulfur, and a patterned negative electrode of zinc. Under the same conditions, a metal-air battery (Pt/C) was manufactured using commercially available Pt/C and RuO₂ as a positive electrode instead of a compound structure of copper, phosphorus and sulfur.

A positive electrode of a compound structure of copper, phosphorus and sulfur was prepared by the following method.

Three suspensions of ethanol/ethylenediamine were prepared, and then dithiooxamide, tetradecylphosphonic acid/ifosfamide, and copper chloride were added and stirred, respectively.

Then, the dithiooxamide solution and tetradecylphosphonic acid/ifosfamide were stirred with a continuous and gradual injection into the copper chloride solution, and stirred for two hours with the addition of ammonium hydroxide.

The resulting black suspension of copper-dithiooxamide-tetradecylphosphonic acid-ifosfamide was refluxed at 120° C. for six hours, collected by centrifugation, washed with deionized water and ethanol, and dried under vacuum.

After that, the obtained precursor suspension of copper-dithiooxamide-tetradecylphosphonic acid-ifosfamide was mixed with deionized water containing Triton X-165 and sodium bisulfite in an ice bath. The reaction suspension was autoclaved and cooled to room temperature. The obtained black solid sponge was washed with deionized water and ethanol until the supernatant reached a neutral pH.

The resulting product was transferred to a −70° C. environment for two hours, immersed in liquid nitrogen, and freeze-dried under vacuum conditions to prepare a positive electrode material of a compound structure of copper, phosphorus and sulfur, and a slurry was prepared by mixing a positive electrode material (90 wt %), super P carbon (5 wt %), and PTFE (5 wt %) with N-methyl-pyrrolidone containing a 0.5 wt % Nafion solution. The slurry was coated on a stainless steel mesh and the solvent was evaporated. After that, the resulting product was cut into a size of 6 cm×1.5 and dried in vacuum to prepare a positive electrode.

As can be understood from FIG. 19, it can be confirmed that an excellent charge/discharge capacity is achieved under the conditions of 25 mAcm⁻² and 50 mAcm⁻². When using the compound structure of copper, phosphorus and sulfur prepared as described above, it can be confirmed that a remarkably high capacity is achieved compared to when using Pt/C and RuO₂.

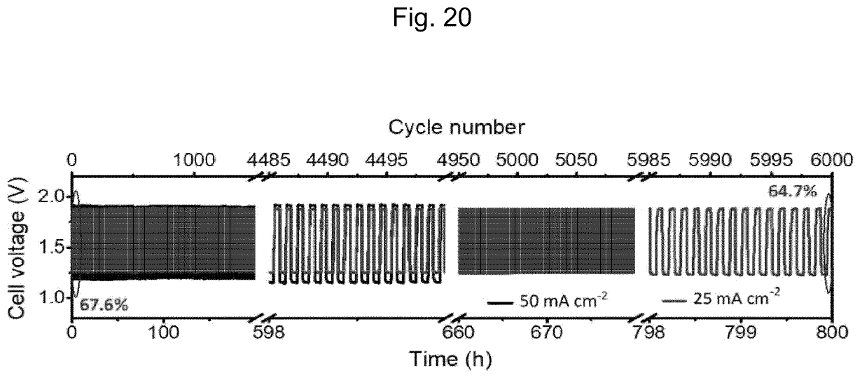

FIG. 20 is a graph showing results of measuring a voltage value of a metal-air battery including a solid electrolyte according to Experimental Example 1-4 of the present application depending on the number of charges/discharges.

Referring to FIG. 20, a voltage value according to the number of charges/discharges was measured under the conditions of 50 mAcm⁻² and 25 mA⁻² with regard to a metal-air battery using a solid electrolyte according to Experimental Example 1-4 as described above with reference to FIG. 19, a positive electrode of a compound structure of copper, phosphorus and sulfur, and a patterned negative electrode of zinc.

As can be understood from FIG. 20, it can be confirmed that stable driving is performed during about 600 times of charging and discharging. In other words, it can be confirmed that the solid electrolyte prepared according to the above-described embodiment of the present invention may be stably used as a solid electrolyte of a metal-air battery.

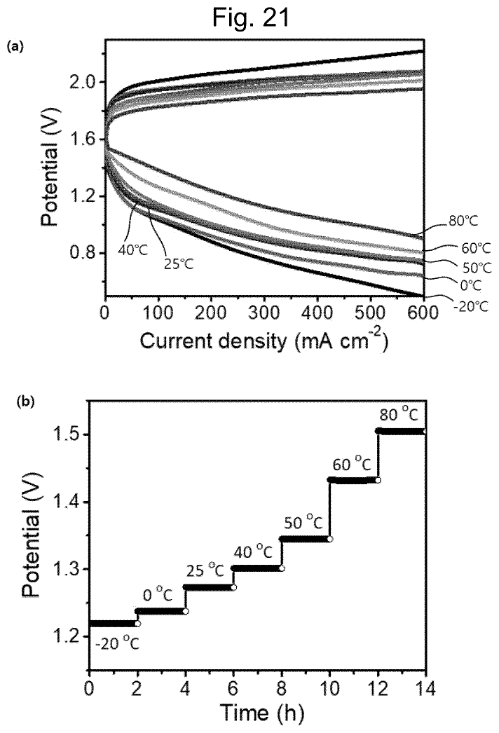

FIG. 21 is a graph for explaining a change in charge/discharge properties of a metal-air battery including a solid electrolyte according to Experimental Example 1-4 of the present application depending on an external temperature condition.

Referring to FIG. 21, a change in charge/discharge properties was measured while an external temperature was changed between −20° C. and 80° C. with regard to a metal-air battery using a solid electrolyte (CBCs) according to Experimental Example 1-4 as described above with reference to FIG. 19, a positive electrode of a compound structure of copper, phosphorus, and sulfur, and a patterned negative electrode of zinc. (b) of FIG. 21 shows that a current density is measured at 25 mAcm².

As can be understood from FIG. 21, it can be confirmed that a voltage value increases and has a low overpotential as a temperature increases. In other words, it can be confirmed that the secondary battery including the solid electrolyte according to Experimental Example 1-4 of the present application is stably driven in high and low temperature environments.

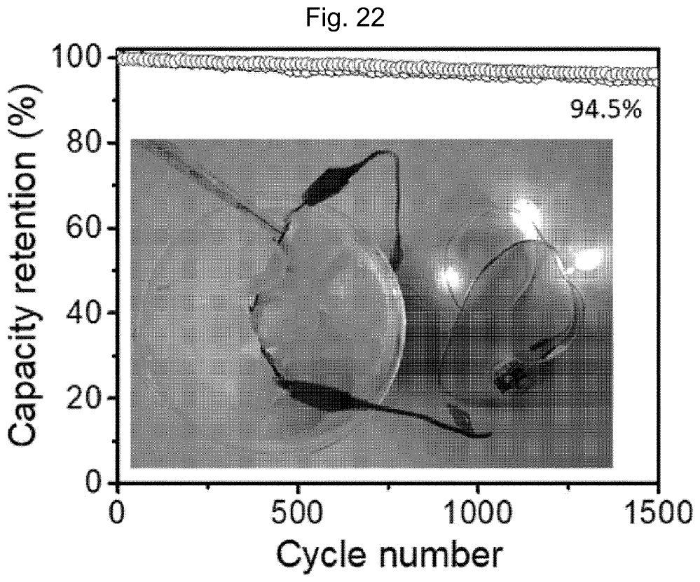

FIG. 22 is a view for explaining retention properties of a metal-air battery including a solid electrolyte according to Experimental Example 1-4 of the present application depending on the number of charges/discharges in low and high environments.

Referring to FIG. 22, a cycle of charge/discharge was performed under the condition of 25 mAcm² while an external temperature is controlled between −20° C. and 80° C. with regard to a metal-air battery using an solid electrolyte (CBCs) according to Experimental Example 1-4 as described above with reference to FIG. 19, a positive electrode of a compound structure of copper, phosphorus and sulfur, and a patterned negative electrode of zinc.

As can be understood from FIG. 22, it can be confirmed that a retention property is slightly deteriorated under the condition of −20° C., but it can be confirmed that a high retention property of about 94.5% is maintained and stable driving is performed even after 1,500 times of charging/discharging at high and low temperatures.

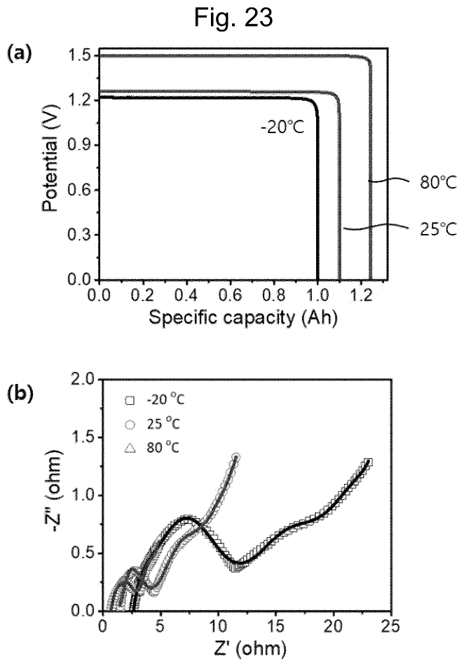

FIG. 23 provides graphs for explaining charge/discharge properties of a metal-air battery including a solid electrolyte according to Experimental Example 1-4 of the present application depending on an external temperature.

Referring to FIG. 23, a voltage of charge/discharge was measured and a Nyquist plot was illustrated under the condition of 25 mAcm⁻² while an external temperature is controlled to −20° C., 25° C., and 80° C. with regard to a metal-air battery using an solid electrolyte (CBCs) according to Experimental Example 1-4 as described above with reference to FIG. 19, a positive electrode of a compound structure of copper, phosphorus and sulfur, and a patterned negative electrode of zinc.

As can be understood from FIG. 23, it can be confirmed that only a slight deterioration in properties is observed in a low-temperature environment, and a stable operation is all performed at low, normal and high temperatures.

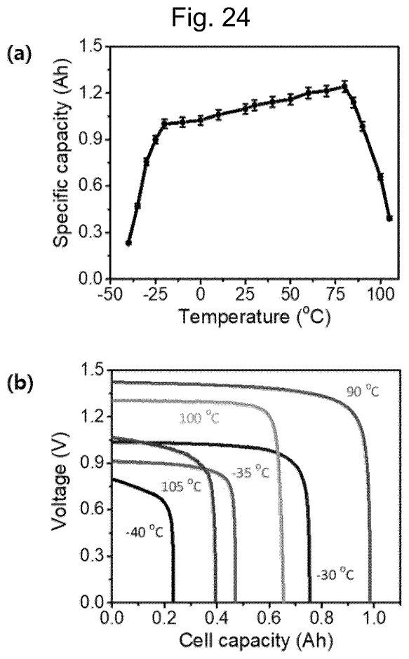

FIG. 24 provides graphs for explaining a capacity property of a metal-air battery including a solid electrolyte according to Experimental Example 1-4 of the present application depending on an external temperature.

Referring to FIG. 24, a capacity was measured under the condition of 25 mAcm² while an external temperature is controlled between −40° C. and 105° C. with regard to a metal-air battery using a solid electrolyte (CBCs) according to Experimental Example 1-4 as described above, a positive electrode of a compound structure of copper, phosphorus and sulfur, and a patterned negative electrode of zinc.

As can be understood from FIG. 24, it can be confirmed that a high capacity of 1 Ah or more is achieved in the range of −20° C. to 80° C. In contrast, it can be confirmed that the mobility of OH ions in the solid electrolyte is rapidly decreased at less than −20° C., and thus the capacity is rapidly decreased, and it can be confirmed that a capacity property is rapidly deteriorated due to an evaporation of solvent in the solid electrolyte at more than 80° C. Specifically, the capacity significantly decreased to 0.234 Ah at −40° C. and significantly decreased to 0.394 Ah at 105° C.

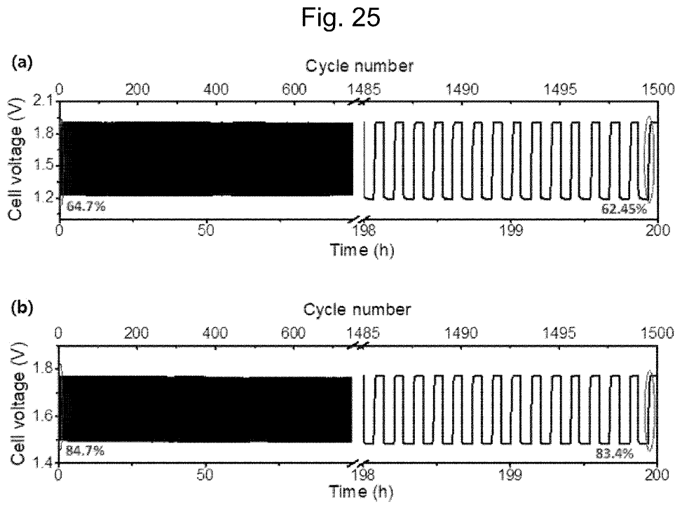

FIG. 25 provides graphs for explaining a change in charge/discharge properties of a metal-air battery including a solid electrolyte according to Experimental Example 1-4 of the present application depending on a charge/discharge cycle caused by an external temperature.

Referring to FIG. 25, charge/discharge were performed 1,500 times for 200 hours under the condition of 25 mAcm² while an external temperature is controlled between −20° C. and 80° C. with regard to a metal-air battery using an solid electrolyte (CBCs) according to Experimental Example 1-4 as described above with reference to FIG. 19, a positive electrode of a compound structure of copper, phosphorus and sulfur, and a patterned negative electrode of zinc. (a) of FIG. 25 shows a result of performing charge/discharge under the condition of −20° C., and (b) of FIG. 25 shows a result of performing charge/discharge under the condition of 80° C.

As can be understood from FIG. 25, it can be confirmed that the charge/discharge properties are slightly deteriorated in a low temperature environment of −20° C., but the battery stably runs for a long time and stably runs for a long time even in a high temperature environment of 80° C.

### Preparing of Base Composite Fiber (CBC) According to Experimental Example 2-1

Acetobacter xylinum was provided as a bacterial strain, and a chitosan derivative was provided.

A Hestrin-Schramm (HS) culture medium containing pineapple juice (2% w/v), the chitosan derivative (2% w/v) and a nitrogen source (Daejeong X by Kisan Bio Co.) was prepared and Acetobacter xylinum was cultured in the Hestrin-Schramm (HS) culture medium at 30° C. for seven days.

The harvested bacterial pellicle was washed with water, washed with an alkali solution at normal temperature to remove unreacted bacterial cells, and purified by centrifugation multiple times using deionized water. Finally, a remaining solvent was evaporated at 100° C. to prepare a base composite fiber (chitosan-bacterial cellulose (CBC)) according to Experimental Example 2-1.

### Preparing of First Composite Fiber (oCBC) According to Experimental Example 2-2

A first composite fiber (oCBC) according to Experimental Example 2-2 was prepared by performing the same process as in the first composite fiber (oCBC) according to Experimental Example 1-2, but using the base composite fiber according to Experimental Example 2-1 instead of the base composite fiber according to Experimental Example 1-1.

### Preparing of Second Composite Fiber (qCBC) According to Experimental Example 2-3

A second composite fiber (qCBC) according to Experimental Example 2-3 was prepared by performing the same process as in the second composite fiber (qCBC) according to Experimental Example 1-3, but using the base composite fiber according to Experimental Example 2-1 instead of the base composite fiber according to Experimental Example 1-1.

### Preparing of Third Composite Fiber (DNA-CBC) According to Experimental Example 2-4

An enzyme solution containing an MES buffer of pH 5.7-6, cellulase R10, macerozyme R10, mannitol and KCl was prepared, and Cucumis sativus or Eruca sativa fragments were provided to the enzyme solution, and then the resulting mixture was infiltrated under vacuum in the dark for 30 minutes and decomposed at room temperature for three hours. After that, the resulting solution was diluted with an MMG solution (mannitol+MgCl2+MES, pH 5.7), and then the undecomposed material was purified using a stainless steel mesh, and centrifuged to obtain an extract. Additionally using an MMG solution, the obtained extract was dispersed again in the MMG solution and precipitated to extract pDNA.

A suspension was prepared by treating the extracted pDNA at a ratio of 3:1 to 3:4 w/w for six hours at normal temperature using Alexa Fluor 488, and the resulting suspension was dialyzed for three days with deionized water using a 100 kDa MWCO dialysis membrane to remove free dye molecules, and finally centrifuged to stain pDNA. It is a process of staining pDNA with a fluorescent dye to further identify the presence or absence of cross coupling reaction of pDNA, and the process may be omitted.

Chitosan was oxidized with sodium hydroxide and deacetylated under N2 at 90° C. for eight hours, and then the resulting product was washed with deionized water several times and dried under vacuum to produce oxidized chitosan. A suspension was prepared by mixing 2 g of oxidized chitosan, 1 g of the first and second composite fibers (0.5 g of the first composite fiber and 0.5 g of the second composite fiber) per 100 ml of a solvent including 0.3% acetic acid.

The prepared suspension was mixed with the treated pDNA, stirred at normal temperature for six hours, and dialyzed to remove unreacted materials, thereby preparing a third composite fiber (DNA-CBC) that is formed as DNA was coupled to the first composite fiber (oCBC) and the second composite fiber (qCBC).

After that, a covalent bond by conjugation of an amino group of chitosan with the first composite fiber (oCBC) and the second composite fiber (qCBC) by amide coupling was performed using N-ethyl-N′-(3-dimethylaminopropyl)-carbodiimide (EDC, 5 mg/ml) and N-hydroxysulfosuccinimide (sulfo-NHS, 5 mg/ml) to strengthen the bonding between DNA and cellulose of the first and second composite fibers (oCBC and qCBC), thereby improving durability.

Then, the reaction product was stirred at 30° C. for 16 hours, cooled, dialyzed and centrifuged, after which the third composite fiber (DNA-CBC) was added to DMSO, cast on a glass substrate, peeled off, and ion-exchanged using an aqueous 1 M KOH solution and 0.1 M ZnTFSI to prepare a solid electrolyte containing the third composite fiber (DNA-CBC).

### Preparing of Functional Fiber According to Experimental Example 2-5

N-methyl-4-piperidone serving as a backbone of a polymer, 2,2,2-trifluoroacetophenone as a reaction catalyst, and p-terphenyl as a functional group were mixed with dichloromethane to prepare a mixture.

Trifluoroacetic acid as a reaction initiator and trifluoromethanesulfonic acid as a reaction rate controlling agent were added to the mixture in ice bath, and reacted for 24 hours to prepare a reaction product in which a p-terphenyl functional group was bound to piperidone, dispersed in ethanol, and then the prepared white precipitate was filtered, washed with water, and treated at 50° C. for 12 hours using K₂CO₃.

The resulting precipitate was washed with water and vacuum dried at 60° C. overnight, and the resulting product was suspended in DMSO and methyl iodide at room temperature for 12 hours. The suspension was poured into diethyl ether, washed with diethyl ether, and vacuum dried at 60° C., thereby preparing a functional fiber including piperidone.

A mixture of the first composite fiber (oCBC) according to Experimental Example 2-2 and the second composite fiber (qCBC) according to Experimental Example 2-3, and the dried product were dissolved in DMSO, cast on a glass plate, and peeled off with deionized water to prepare a solid electrolyte including the functional fiber according to Experimental Example 2-5. After that, the membrane was ion-exchanged at 1 M KOH, washed with DI water, and dried.

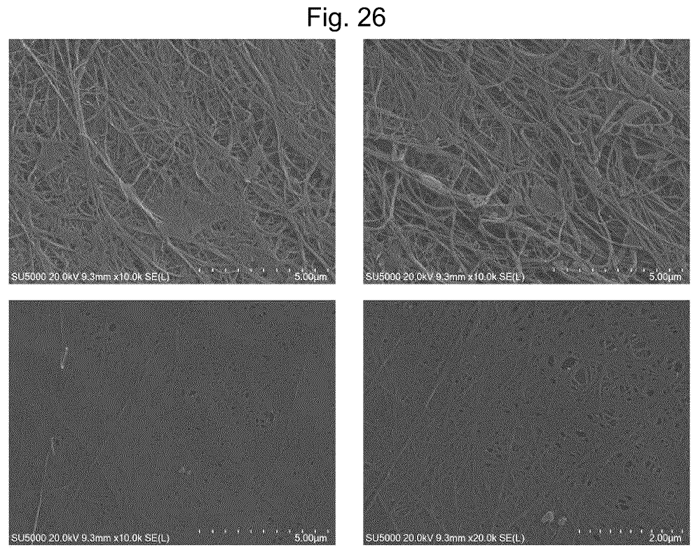

FIG. 26 is a view showing pictures of an SEM image of a solid electrolyte including a third composite fiber according to Experimental Example 2-4 of the present application.

Referring to FIG. 26, a picture of an SEM image was taken of the third composite fiber according to Experimental Example 2-4 of the present application.

As shown in FIG. 26, it can be confirmed that fibers having a diameter of about 10-30 nm form a network even after DNA is coupled.

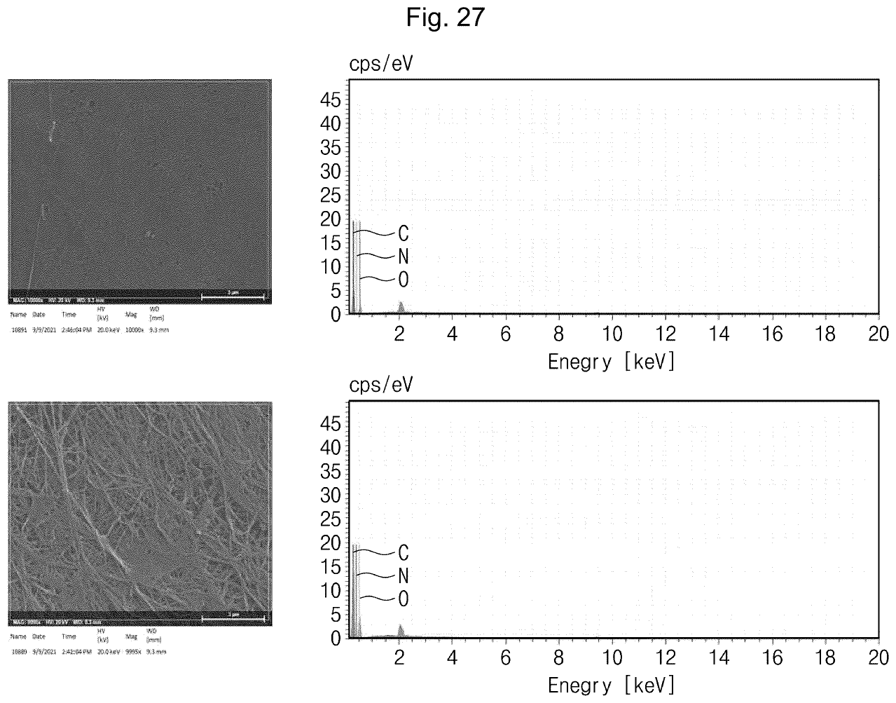

FIG. 27 is a view showing SEM pictures of and results of an EDS analysis on a solid electrolyte including a third composite fiber according to Experimental Example 2-4 of the present application.

Referring to FIG. 27, an EDS analysis on the third composite fiber according to Experimental Example 2-4 of the present application was performed as shown in <Table 2> and <Table 3>. <Table 2> corresponds to the EDS data in an upper part of FIG. 27, and <Table 3> corresponds to the EDS data in a lower part of FIG. 27.

As can be understood from FIG. 27, it can be confirmed that the third composite fiber may include DNA and thus have nitrogen.

TABLE 2

| Element | Mass (%) | Atom (%) |
|---|---|---|
| C | 50.17 | 56.28 |
| O | 35.11 | 29.57 |
| N | 14.71 | 14.15 |

TABLE 3

| Element | Mass (%) | Atom (%) |
|---|---|---|
| C | 51.75 | 58.08 |
| O | 37.61 | 31.68 |
| N | 10.64 | 10.24 |

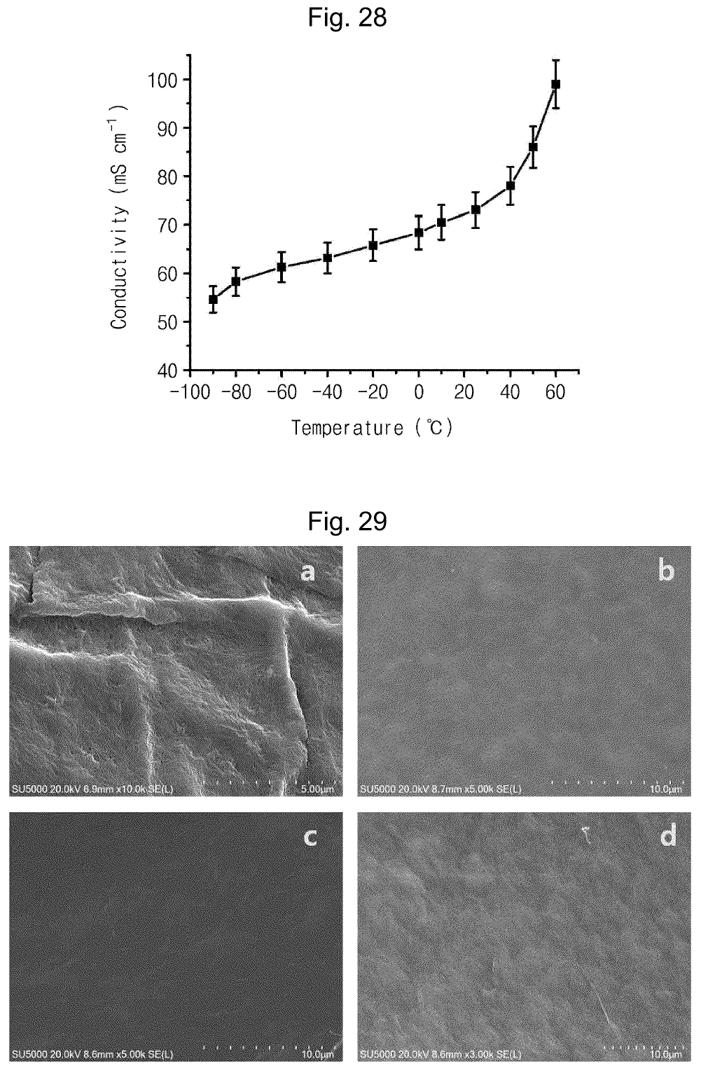

FIG. 28 is a view showing results of measuring an ionic conductivity of a solid electrolyte including a third composite fiber according to Experimental Example 2-4 of the present application depending on a temperature.

Referring to FIG. 28, with regard to the solid electrolyte including the third composite fibers according to Experimental Example 2-4 of the present application, the ionic conductivity for OH ions was measured while a temperature was changed between −90° C. and 60° C.

As can be understood from FIG. 28, it was confirmed that the solid electrolyte prepared using the third composite fiber including DNA maintained a high ionic conductivity between −90° C. and 60° C. In other words, it can be confirmed that a relatively excellent ionic conductivity is achieved in a low-temperature environment compared to the solid state electrolyte according to Experimental Example 1-4 prepared using the first composite fiber (oCBC) and the second composite fiber (qCBC) to which DNA was not coupled. In conclusion, it can be seen that preparing a solid electrolyte using the third composite fiber including DNA is an efficient method of improving a low-temperature operation property of the solid electrolyte.

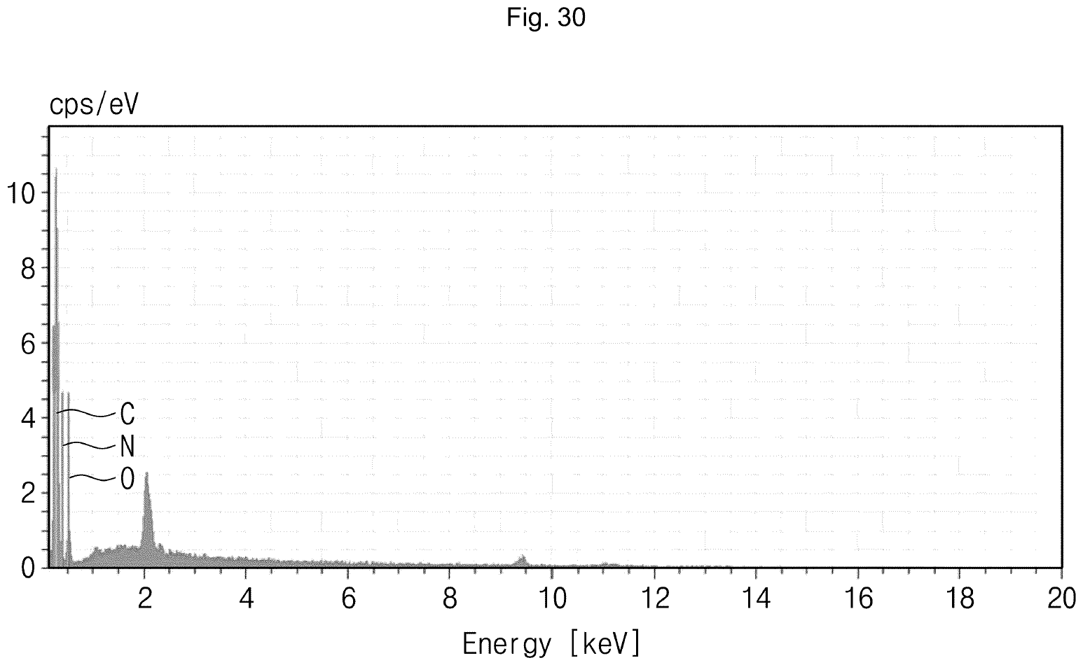

FIG. 29 is a view showing SEM pictures of a solid electrolyte including a third composite fiber according to Experimental Example 2-4 and a functional fiber according to Experimental Example 2-5 of the present application, and FIG. 30 is a view showing results of an EDS analysis on a solid electrolyte including a functional fiber according to Experimental Example 2-5 of the present application.

Referring to FIGS. 29 and 30, (a) and (b) of FIG. 29 are SEM images of the solid electrolyte including the third composite fiber according to Experimental Example 2-4, and (c) and (d) of FIG. 29 are SEM pictures of the solid electrolyte including the functional fiber according to Experimental Example 2-5, and an EDS analysis on the solid electrolyte including the functional fiber according to Experimental Example 2-5 was performed as shown in <Table 4> below.

As can be understood from FIGS. 29 and 30, it can be confirmed that a content of carbon and nitrogen was increased compared to the solid electrolyte including the third composite fiber according to Experimental Example 2-4.

TABLE 4

| Element | Mass (%) | Atom (%) |
|---|---|---|
| C | 60.40 | 65.53 |
| O | 20.45 | 16.66 |
| N | 19.14 | 17.81 |

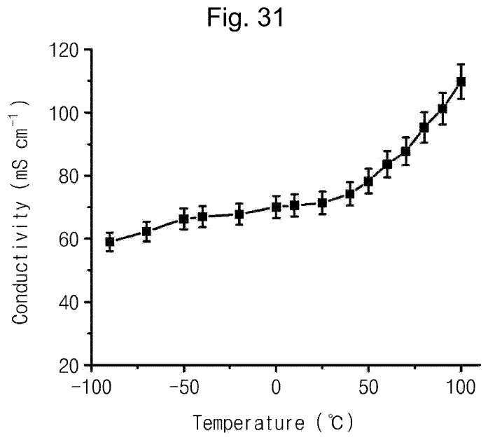

FIG. 31 is a view showing results of measuring an ionic conductivity of a solid electrolyte including a functional fiber according to Experimental Example 2-5 of the present application depending on a temperature.

Referring to FIG. 31, with regard to the solid electrolyte including the functional fiber according to Experimental Example 2-5 of the present application, the ionic conductivity for OH ions was measured while a temperature was changed between −90° C. and 100° C.

As can be understood from FIG. 31, it can be confirmed that the solid electrolyte prepared using the functional fiber including piperidone maintains a high ionic conductivity between −90° C. and 100° C. In other words, it can be confirmed that the above-mentioned solid electrolyte has relatively excellent ionic conductivity in a high-temperature environment compared to the solid state electrolyte according to Experimental Example 1-4 prepared using the first composite fiber (oCBC) and the second composite fiber (qCBC), which did not include a functional fiber containing piperidone, as well as the solid electrolyte according to Experimental Example 2-4 prepared using the third composite fiber (DNA-CBC). In conclusion, it can be seen that preparing a solid electrolyte using the functional fiber including piperidone is an efficient method of improving a high-temperature operation property of the solid electrolyte.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

A composite fiber and a solid electrolyte including the same according to an exemplary embodiment of the present application may be used in various industrial fields such as a secondary battery, a fuel battery, a water electrolysis system, etc.

What is claimed is:

1. A solid electrolyte comprising:
a base composite fiber including bacterial cellulose and chitosan; and
DNA bound to a surface of the base composite fiber.

2. The solid electrolyte of claim 1, further comprising:
a carboxyl group or a DABCO group, which is bound to a surface of the base composite fiber.

3. The solid electrolyte of claim 1, wherein a low-temperature operation property of the solid electrolyte is improved by the DNA.

4. The solid electrolyte of claim 1, comprising:
a first composite fiber that is formed as a surface of the base composite fiber is oxidized; and
a second composite fiber that is formed as a first functional group having nitrogen is bound to a surface of the base composite fiber.

5. A solid electrolyte comprising:
a base composite fiber including bacterial cellulose and chitosan; and
a functional fiber having piperidone as a backbone.

6. The solid electrolyte of claim 5, further comprising:
a terphenyl group bound to a surface of the functional fiber.

7. The solid electrolyte of claim 5, wherein a high-temperature operation property of the solid electrolyte is improved by the functional fiber.

8. The solid electrolyte of claim 5, comprising:
a first composite fiber that is formed as a surface of the base composite fiber is oxidized; and
a second composite fiber that is formed as a first functional group having nitrogen is bound to a surface of the base composite fiber.

9. A method for preparing a solid electrolyte, the method comprising:
providing a base composite fiber including bacterial cellulose and chitosan;
adding oxidized chitosan to a solvent and mixing with the base composite fiber to prepare a mixture; and
adding DNA to the mixture and causing a reaction therebetween to bind the DNA to a surface of the base composite fiber.

10. The method of claim 9, wherein the oxidized chitosan is prepared by treating the chitosan with sodium hydroxide.

11. A method for preparing a solid electrolyte, the method comprising:
providing a base composite fiber including bacterial cellulose and chitosan;
providing a functional fiber having piperidone as a backbone; and
mixing the base composite fiber and the functional fiber to prepare a solid electrolyte.

12. The method of claim 11, further comprising:
a terphenyl group bound to a surface of the functional fiber.
